(19) United States
(12) Patent Application Publication
(10) Pub. No.: US 2003/0187763 A1
(43) Pub. Date: Oct. 2, 2003

(54) Intelligent inter-organizational system for procurement and manufacturing

(75) Inventors: Cecil W. Jordan, Livermore, CA (US); Francine A. Alford, Livermore, CA (US); Horst D. Bissinger, Henderson, NV (US); Arie Segev, Walnut Creek, CA (US)

Correspondence Address: Eddie E. Scott, Assistant Laboratory Counsel, Lawrence Livermore National Laboratory, P.O. Box 808, L-703, Livermore, CA, 94551, US

(73) Assignee: The Regents of the University of California

(21) Appl. No.: 10/108,254

(22) Filed: Mar. 26, 2002

(51) Int. Cl. G06F 17/60

(52) U.S. Cl. 705/35

(57) ABSTRACT

An intelligent inter-organizational computer-implemented system to support inter-organizational business transactions. The system includes a component for preparing fabrication files, a component for entering fabrication requests on job orders, a component for job ordering/validating drawings/modeling, a component for job ordering/obtaining manufacturing documents, a component for job ordering/obtaining reference specs, a component for job ordering/adding local documents, a component for accessing procurement package for bidding, a component for awarding orders, a component for access to manufacturing package for fabrication, a component for entering inspection documents, and a component for entering shipping information.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to inter-organizational systems and more particularly to inter-organizational systems for procurement and manufacturing.

2. State of Technology

U.S. Pat. No. 6,035,297 to Van Huben, et al. patented Mar. 7, 2000, for a data management system for concurrent engineering developed by International Business Machines, provides the following description: “In the article entitled “Beyond EDA (electronic design automation)”, published in Electronic Business Vol. 19, No. 6 June 1993 P42-46, 48, it was noted that while billions of dollars have been spent over the past (then and still last) five years for electronic design automation systems (EDA) arid software to help companies cut their design cycle, a huge gulf remains between design and manufacturing. To eliminate the gulf and thus truly comply with the commandments, companies are extending the concept of concurrent engineering to enterprise wide computing. The concept, which calls for integrating all the disciplines from design to manufacturing is becoming the business model of the 1990s. Achieving an enterprise wide vision requires tying together existing systems and programs and managing the data that flows among them. Software that makes that linkage possible is largely in the class known by two names: product data management (PDM) or product information management (PIM). Mr. Robinson, the author, described the experiences of several companies with PIM and PDM, in particular Sherpa and Cadence. The design of complex parts, such as integrated circuits, computers, or other complex machines in a complete manufacturing operation like IBM's requires computer capability, with computers capable of processing multiple tasks, and allowing concurrent data access by multiple users. The IBM System 390 operating system known as Multiple Virtual Storage (MVS) allows such things as relational database management methods, such as the TIME system described by U.S. Pat. No. 5,333,316, to be used to reduce design time. The TIME system is used within IBM for the purposes described in the patent during circuit design.”

U.S. Pat. No. 5,201,047 to Maki, et al. patented Apr. 6, 1993 provides the following description: “Group technology is a loosely bounded manufacturing philosophy that exploits similarities in parts for efficiency in design and manufacture. It has evolved from parts classification and coding systems that were developed for engineering design retrieval. Parts may also be classified and coded by process, tooling, set up, or any other useful feature set. Companies using group technology principles have found that it can be applied to other business functions, including marketing, purchasing, cost accounting, materials control, and customer service. Group technology is most commonly used for parts (or items) classification. An objective of parts classification is to provide a system to classify and locate parts with similar attributes. It helps to eliminate duplicate parts with different part numbers and avoids complete redesign of parts that are very similar. Virtually all group technology implementations use computer assisted classification coding as a method of defining families of similar parts within the manufacturing enterprise. A parts classification code is a string of characters, usually digits, that specifies the design and/or manufacturing attributes of the part. Many such coding systems are commercially available. Currently, all parts classification systems use a fixed format code that identifies specific attributes of a part in a predefined schema. The code may be intelligible to the user or machine readable only, but its format is fixed at the time the code is generated. If the schema has multiple hierarchical levels, they are reflected in the code format. The fixed format code creates problems with maintenance as a company and its classification system change over time. There may be some room in the existing format for minor additions to existing codes, but generally any significant maintenance to the classification schema will require a time consuming reclassification of all parts. As parts classification codes are used more extensively for such group technology applications as computer aided process planning, there will be increased maintenance to the classification schema. Current automated methods of classification systems for group technology are limited to assigning classification codes to manufactured parts or other business entities and processes. The assigned codes are then used for query purposes. General purpose query tools are inefficient for classification queries. Special purpose programs to improve the performance result in preplanned classification queries which are inflexible. A query system for classification queries that is both flexible and yields high performance is not commercially available. Thus, there exists a need for a codeless classification system that removes the hierarchical code from the parts data, thus avoiding the time-consuming reclassification that is necessitated when the code hierarchy changes. Furthermore, there is a need for a codeless classification system which enables definition of unique attributes for a specific class of entity and allows queries on the attribute values.”

U.S. Pat. No. 5,321,605 to Chapman, et al. patented Jun. 14, 1994 provides the following description: “Organizations engage in activities to achieve organizational goals. For a manufacturing organization, such activities may relate to the manufacture of a product or of several products. For a provider of services, such activities may relate to the performance of a service or of many different services. In many organizations, and particularly in large or complex organizations, the manufacture of products and the performance of services require the completion of a large number of diverse activities in specific sequences relative to one another to achieve organizational goals. In order to manage these activities, organizations often perform information gathering and processing tasks related to describing the activities and their relative order. Such descriptions are referred to as process flows and may characterize the manufacturing of products, the performance of services, or other organizational goals. These process flows are useful in planning, simulating, and controlling realization of the described products and services. Conventional systems for managing process flows are typically adapted to describe a relatively simple organization. Such simple organizations have no more than a few products or services to be described with process flows. Critical Path Method (CPM), Project Evaluation and Review Technique (PERT), and Material Requirements Planning (MRP) represent a few of the conventional techniques which support and manage process flows. When more complex organizations utilize such conventional systems, they are forced to duplicate or repeat usage of the systems for various products or services. As a result, the process flows for these products or services are independent from one another. In other words, process flows are constructed and exist in isolation of one another. However, in reality different products and services of a complex organization tend to be interrelated with one another. For example, diverse products and services must compete to receive commonly used resources. Thus, these diverse products and services are related to one another through their demands for commonly used resources. Likewise, economies of scale may be realized by identifying and forcing roughly equivalent components of diverse process flows to be more similar. For example, if a “widget” product requires the use of one brand of red paint and a “gadget” product requires the use of another brand of red paint, two different brands of red paint must be purchased, inventoried, and managed. However, by recognizing the similarity between the paint requirements and forcing one of the products to use the other product's brand of paint, economies of scale are achieved in purchasing larger quantities of a single brand of paint and in inventorying only one brand of paint. Accordingly, diverse products and services are related through similar components between the products' and services' process flows. Due to this interrelation between products and services of a complex organization, conventional systems fail to provide satisfactory process flows. Specifically, conventional process flow information management systems fail to promote standardization in characterizing process flows related to diverse organizational tasks. Consequently, opportunities for achieving economies of scale are missed. Moreover, process flow information quickly gets out of control, and organizations must expend large quantities of organizational resources to manage numerous process flows. Furthermore, conventional systems for managing process flow information fail to satisfactorily account for the dispersion of expert knowledge within a typical complex organization. Thus, such systems inadequately permit a single person to create, modify, and otherwise manage, for the entire organization, many related process flows. Consequently, the expert's knowledge is often used inefficiently by the organization while non-experts manage flows related to areas beyond their expertise. Inaccurate and incomprehensive process flows result.

U.S. Pat. No. 5,418,949 to Suzuki patented May 23, 1995 for a page map, metamap, and relation group file management supervised by operation means for allocating, storing, and searching friendly and exclusive data items developed by Fujitsu Limited provides the following description: “A file storage management system for managing pages in a file, in which pages, data items belonging to a plurality of relations are stored. The file storage management system includes a data file for storing data items belonging to relations page by page, a page map file storing information representing positions at which data pages and empty pages are positioned in the file, a metamap file for storing metamap information representing whether or not the data empty pages and the data pages exist in each page map, relation group definition file for information representing whether relations are friendly relations or exclusive relations a page management unit for managing the data file, a page map management unit for managing the page map file, a metamap management unit for managing the metamap file, a relation group management unit for managing the relation group definition file, and page operation unit for operating the page management unit, the page map management unit, the metamap management unit, the relation group management unit so that a process for allocating data items belonging to relations to pages, and a process for searching for pages to be released from management in the system and for pages storing data items to be loaded into a main memory are carried out.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a computer and internet implemented system for supporting inter-organizational business transactions. The system utilizes the steps of: preparing fabrication files, validating drawings and/or models, obtaining manufacturing documents, obtaining reference specifications, accessing procurement packages for bidding, awarding orders, accessing manufacturing packages for fabrication, and entering shipping information. In one embodiment of the invention collaboration between the sub-contract administrators, technical points of contact, and manufacturers is provided prior to and after contract award. In one embodiment of the invention the system includes adding local documents. In another embodiment of the invention the system includes entering fabrication requests on job orders. In one embodiment of the invention the system includes entering requests for information. In another embodiment of the invention the system includes entering engineering change requests. In one embodiment of the invention the system includes entering engineering change orders. In one embodiment of the invention the system includes entering material dispositions. In another embodiment of the invention the system includes entering inspection documents.

One embodiment of the present invention provides a basic engineering-business model which focuses on inter-organizational buying and engineering technical data exchange processes required to produce complex laser-optical parts assembled into 15 basic products by 34 large, medium, and small optical firms. The basic engineering-business model requires engineering support and services through matrixed resident organizations and contracted commercial engineering services firms. The outcome of the engineering processes (i.e., the design and manufacturing of complex systems) is based on tight collaboration among engineering specialists, not only within the parent organization but also with partners of other research institutions, manufacturers, and suppliers. In some cases it even stretches beyond national and continental borders. The basic engineering-business model is supported at the parent organization by a host of matrixed organizations including mechanical and electronics engineering.

The scope of specialized optical components in this model exceeds 40,000 pieces. These elements will be assembled into 192 highly energetic laser beams each dependent upon the availability of pre-selected optical spare components for operational maintenance. Each optical element will be procured, manufactured, maintained, consumed, and reordered many times over a projected 30-year lifetime. Alliance partners are classified as either primary or secondary contractors based on their functional role (major or supplemental) in the supply-chain process.

There is a limited trading community of pre-qualified optical manufacturing firms that share common characteristics including: a common product database of manufacturer fabrication and coating qualifications, prime and secondary firms must form product-alliances to bid on a particular assembly, contractors must pass both procurement and technical information between alliances and the parent organization, and no alliance partner currently has an inter-organizational system capable of supporting such requirements. Inter-organizational engineering procurement transactions can be supported by technical modifications to a properly selected enterprise system exploiting rules-based forms, workflow, automatic e-mail notification, and web-based portal interfaces which permit bi-directional, structured inter-organizational communication. Inter-organizational users, buyers and sellers, are internet savvy (i.e. surf the web), have access to ISP services which provide internet connectivity, e-mail, and sufficient network bandwidth to transfer files in acceptable time frames for business purposes.

Inter-organizational users will use the Web based portal interface to conduct business, form manufacturing alliances, bid-quote as manufacturing units, and provide accurate procurement, financial billing, technical manufacturing data, timely source inspection including final acceptance testing, and shipping information in a timely manner using a Web portal interface.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates an embodiment of the present invention that has particular utility in procurement of complex, highly integrated electronics, electro-optics, optical, and mechanical assemblies.

FIG. 2 is a diagram showing manufacturing alliances.

FIG. 3. illustrates the system whereby authorized vendors access documents through iDocMan.

FIG. 4 shows a diagram of the system workflow of another embodiment of the present invention.

FIG. 5 shows a diagram of the system workflow of another embodiment of the present invention.

### DETAILED DESCRIPTION OF THE INVENTION

Referring now to the drawings, to the following detailed information, and to incorporated materials; a detailed description of the invention, including specific embodiments, is presented. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims. Various definitions, acronyms, and abbreviations will be used throughout the description of the embodiments described below. The definitions, acronyms, and abbreviations are listed below.

Definitions, Acronyms, and Abbreviations

| | |
|---|---|
| AIS | Administrative Information Systems |
| BO | Blanket Order |
| CAD | Computer Aided Design |
| CAM | Computer Aided Manufacturing |
| CEA | French Commissariat à l'Énergie Atomique |
| CERPS | Concurrent Engineering Rapid Prototype System |
| Docman | Internet Document Management |
| DOE | Department of Energy |
| DM | Document Management |
| ECI | Engineering and Commerce on the Internet |
| IEEE | Institute of Electrical and Electronic Engineers |
| GUI. | Graphical User Interface. |
| iDocMan | An Inter-Organizational Portal Architecture |
| IMD | Information Management Division |
| ISM | Independent Service Provider |
| JO | Job Order |
| Livelink | A Management Application for Web-Based Solutions |
| LLNL | Lawrence Livermore National Laboratory |
| LIAM | Livermore Information And Methods Integrated |
| | Collaborative Engineering and Electronic Commerce |
| MDMS | Metrology Data Management System |
| MTA | Master Task Agreement |
| NIF | National Ignition Facility |
| NIS | NIF Information Systems |
| NQA | NIF Quality Assurance |
| OLR. | On-Line Requisition System. |
| P&M | Procurement and Materiel Department |
| PDF | Portable Document Format |
| PO | Purchase Order |
| ProCard | LLNL Charge Card |
| PARIS. | Procurement and Receiving Information System. |
| SA | Procurement Subcontract Administrator |
| Sherpa | Product Data Management System |
| SME | Small and medium enterprises |
| SRS | Software Requirements Specification. |
| Std. | IEEE Guide to Software Requirements Specifications. Std |
| | 830-1984 (T.) |
| TOPS | LLNL's Total Online Procurement System |
| TPC | Technical Point of Contact |
| TRR. | Technical Release Representative |
| Zephyr | LLNL initiative meaning online integration of the concept- |
| | to-delivery and payment cycle |

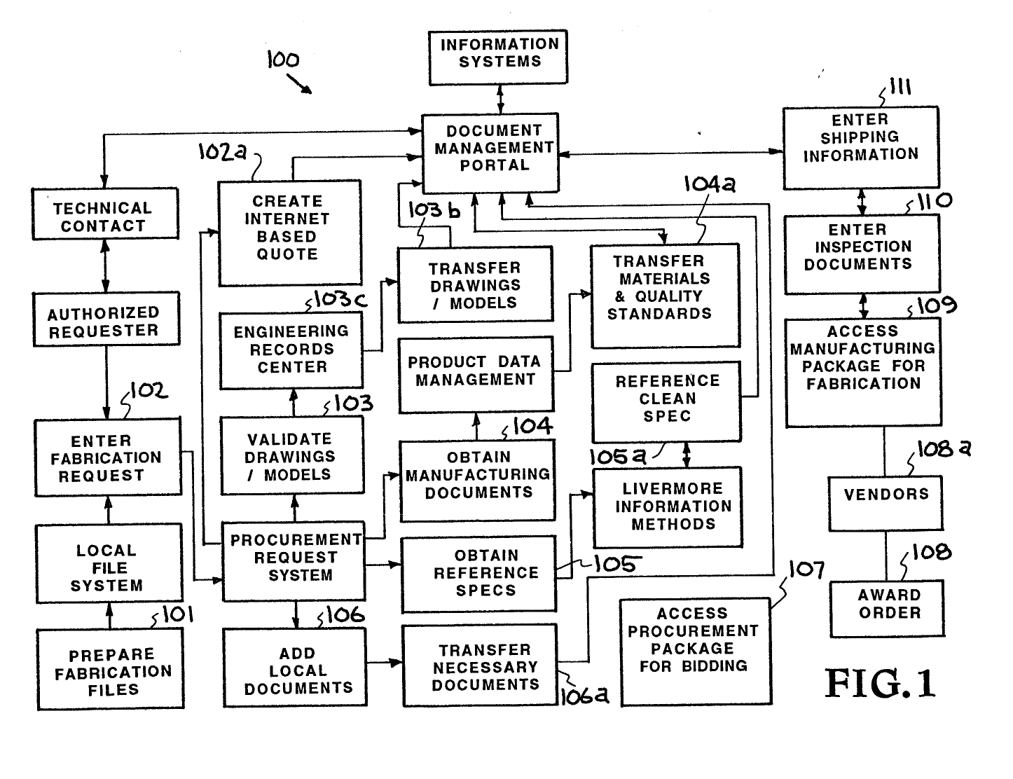

Referring now to FIG. 1, an embodiment of the present invention will be described in connection with a project for the National Ignition Facility at Lawrence Livermore National Laboratory. Lawrence Livermore National Laboratory (LLNL) is a DOE research and development laboratory operated and managed by the University of California. LLNL has about 8,000 employees and an annual budget of about $1 billion. The National Ignition Facility (NIF) at LLNL will integrate the Inertial Confinement Fusion Program into the overall Stockpile Stewardship Program and to foster the development of associated laser technologies such as those developed in the Laser Science and Technology Program. The NIF Project under construction in Livermore California is the largest laser in the world. Some aspects of the NIF project are: the facility is very large, the size of a sports stadium; the target is very small, the size of a BB-gun pellet; the laser system is very powerful, equal to 1,000 times the electric generating power of the United States; and each laser pulse is very short, a few billionths of a second. Experiments in NIF will access high-energy-density and fusion regimes with direct applications to stockpile stewardship, energy research, science, and astrophysics.

Referring again to FIG. 1, the embodiment of the present invention is generally designated by the reference numeral 100. The system 100 will be described in the context of procurement of complex, highly integrated electronics, electro-optics, optical, and mechanical assemblies for the National Ignition Facility (NIF). Upon its planned completion estimated in 2006, the NIF will host the world's largest laser and include 192 laser sub-systems, which will be controlled and focused with 42,500 optical elements. The laser beams will focus jointly on a single pin-sized point. Together they will produce more than 1,000 times the U.S. peak generating power and create conditions that prevail at the center of the sun. This will allow researchers to measure temperature, pressure, and other properties of nuclear reactions. The facility will also support research in inertial confinement fusion and basic science such as astrophysics. It is one of the largest high technology construction projects in the world. Engineering design began in 1996, construction started in 1997, and all 192 beams are scheduled to be available for experiments by the end of 2006.

The size and sophistication of the NIF project has posed supply chain challenges for engineering and procurement. New components and controls were developed as well as new techniques for troubleshooting and maintaining the giant laser. The efforts have included innovative component replacement strategies and increased standards for component quality and specification matching. The NIF project relies on collaboration with commercial manufacturers and other national labs, such as Sandia and Los Alamos National Laboratories. This includes collaboration with research facilities such as the University of Rochester and the French Commissariat à l'Énergie Atomique (CEA). Total cost of the NIF project is estimated to be over $2 billion and involve nearly 25% LLNL's employees. Over 75% of the cost of the project will be spent on construction and manufacturing. The system 100 automates critical parts of optical manufacturing for a complex laser system. The system 100 uses the iDocMan system to extend a conceptual manufacturing model to intelligent inter-organizational manufacturing. Lawrence Livermore National Laboratory's (LLNL) iDocMan portal architecture is an inter-organizational application to support engineering and procurement processes based on the Internet and World Wide Web.

The basic engineering portion of system 100 will focus on inter-organizational buying and engineering technical data exchange processes required to produce complex laser-optical parts assembled into 15 basic products by 34 large, medium, and small optical firms. The basic engineering portion of system 100 requires engineering support and services through matrixed resident organizations and contracted commercial engineering services firms. The outcome of the engineering processes (i.e., the design and manufacturing of complex systems) is based on tight collaboration among engineering specialists, not only within LLNL but also with partners of other research institutions, manufacturers, and suppliers. In some cases it even stretches beyond national and continental borders. NIF is supported at LLNL by a host of matrixed organizations including mechanical and electronics engineering. The scope of specialized optical components exceeds 40,000 pieces. These elements will be assembled into 192 highly energetic laser beams each dependent upon the availability of pre-selected optical spare components for operational maintenance. Each optical element will be procured, manufactured, maintained, consumed, and reordered many times over a projected 30-year lifetime. Alliance partners are classified as either primary or secondary contractors based on their functional role (major or supplemental) in the supply-chain process.

The limited trading community of pre-qualified optical manufacturing firms share at least five common characteristics: a common product database of manufacturer fabrication and coating qualifications, prime and secondary firms must form product-alliances to bid on a particular assembly, proprietary information must not be shared within product-alliances or with others, contractors must pass both procurement and technical information between alliances and LLNL, and no alliance partner currently has an inter-organizational system capable of supporting such requirements. Three fundamental assumptions are made: inter-organizational engineering procurement transactions can be supported by technical modifications to a properly selected enterprise system exploiting rules-based forms, workflow, automatic e-mail notification, and web-based portal interfaces which permit bidirectional, structured inter-organizational communication; inter-organizational users, buyers and sellers, are internet savvy (i.e. surf the web), have access to ISP services which provide internet connectivity, e-mail, and sufficient network bandwidth to transfer files in acceptable time frames for business purposes; and inter-organizational users will use the proposed Web based portal interface to conduct business, form manufacturing alliances, bid-quote as manufacturing units, and provide accurate procurement, financial billing, technical manufacturing data, timely source inspection including final acceptance testing, and shipping information in a timely manor using a Web portal interface.

As illustrated by the flow chart shown in FIG. 1, the present invention provides an intelligent inter-organizational computer-implemented system to support inter-organizational business transactions system 100. The system 100 includes the constituents listed in the table below.

| Reference No. | Constituent |
|---|---|
| 101 | Prepare Fabrication Files |
| 102 | Enter Fabrication Request on Job Order (JO) |
| 102A | Create Internet Based Request for Quote |
| 103 | JO/Validate Drawings/Models |
| 103A | Transfer Drawings/Models |
| 104 | JO/Obtain Manufacturing Docs |
| 104A | Transfer Drawings/Models |
| 105 | JO/Obtain Reference Specs |
| 105A | (Reference Cleanliness Specs) Livermore Information |
| | and Methods |
| 106 | JO/Add Local Docs |
| 106A | Transfer Other Necessary Docs |
| 107 | Access Procurement Package for Bidding |
| 108 | Awarding Order |
| 109 | Access Manufacturing Package for Fabrication |
| 110 | Enter Inspection Docs |
| 111 | Entering Shipping Info |

The entries are made through a “Document Management Portal” into “Information Systems.” The steps of 101 Prepare Fabrication Files and 102 Enter Fabrication Request on Job Order (JO) are completed using a “Local File System.” The followings systems are automated process: 102A Create Internet Based Request for Quote, 103A Transfer Drawings/Models, 104A Transfer Drawings/Models, 105A Reference Cleanliness Specs, and 106A Transfer Other Necessary Docs.

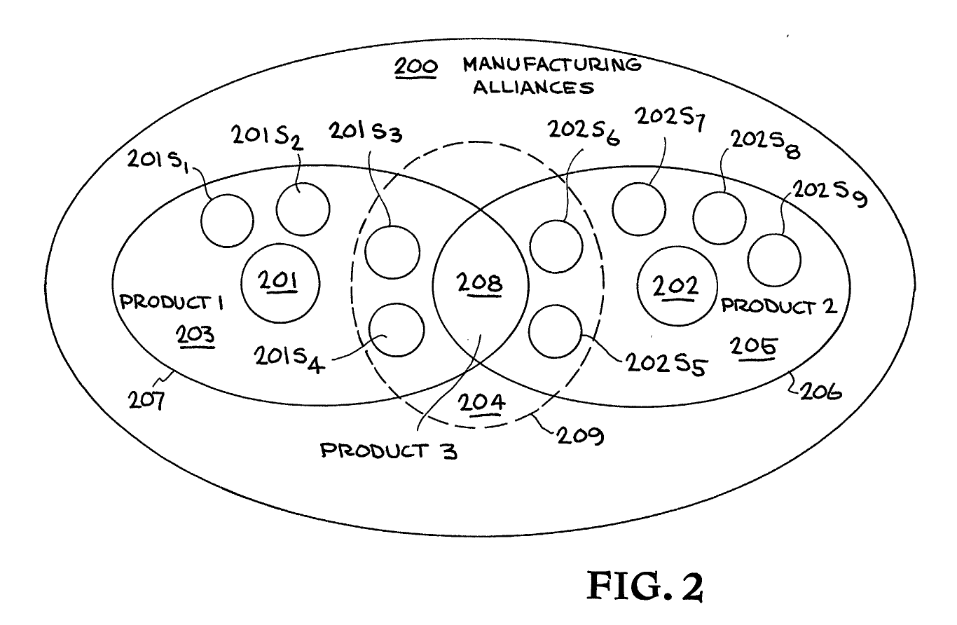

FIG. 2 is a diagram showing the manufacturing alliances, designated generally by the reference numeral 200. Virtual manufacturing alliances are formed between a limited number of pre-approved prime (large enterprises) and secondary (medium and small) contractors such that the number of secondary contractors exceeds primes by a factor of one or more. The prime contractors are designated by the reference numerals 201 and 202. The secondary contractors are designated by the reference numerals 201S₁, 201S₂, 201S₃, 201S₄ 202S₅, 202S₆, 202S₇, 202S₈, and 202S₉. The product 1 designated by the reference numeral 203 is produced by the prime contractor 201 and secondary contractors 201S₁, 201S₂, 201S₃, and 201S₄. The product 2 designated by the reference numeral 205 is produced by the prime contractor 202 and secondary contractors 202S₅, 202S₆, 202S₇, 202S₈, and 202S₉. The product 3 designated by the reference numeral 204 is produced by the combination of prime contractors 201 and 202, their secondary contractors, and even additional contractors.

Each prime-secondary alliance is capable of producing one or more products (i.e. prime-alliance 1, produces product 1, etc). Additional product capability exists when prime-alliances have excess manufacturing capacity. Secondary contractors have an economic incentive to find and align with prime 3 to produce product 3 to maximize collective manufacturing capacity. Deterministic request for quote (RFQ) announcements to a limited trading community, through a secure inter-organizational Web portal, hold promise for driving alliances to maximize manufacturing efficiency and economic interests.

A buyer managing such tertiary alliances can maximize trading community manufacturing capacity, reduce product cost, and increase competitive bidding. Small and medium enterprises (SME) are flexible and aggressive in seeking such relationships and routinely compete vigorously in such markets. The Laboratory's Procurement & Materiel Department sponsored extensions to LLNL's procurement systems to expand the range of products supported to include non-standard, high-value, engineering items that are not usually procured electronically, such as mechanical, optical, and electronic parts, assemblies, and turn-key operational systems.

The resulting “TOPS Job Order” capability, (sub-system of LLNL's Total Online Procurement System), minimizes the manual process associated with processing fabrication requests, adds the necessary controls to insure the authenticity of drawings to be fabricated, and increases support for associated engineering documents including Computer Aided Design (CAD) and Computer Aided Manufacturing (CAM) models. In addition, deploying TOPS Job Order as a portal service within iDocMan provided a secure Web interface for vendors bidding on fabrication requests.

Using the TOPS Job Order system, Laboratory Technical Release Representatives (TRRs) are able to initiate fabrication requests, and can perform a request for quote process without the assistance of a buyer within their delegated level of authority, generally $10-100K, or can submit items of higher value (>$100K) to a buyer for processing.

In both instances, iDocMan is used to provide the interface for vendors bidding on fabrication requests, which has substantially reduced the time and cost of procurement for fabrications while providing additional “need-to-know” design information normally too costly to reproduce as part of a procurement package.

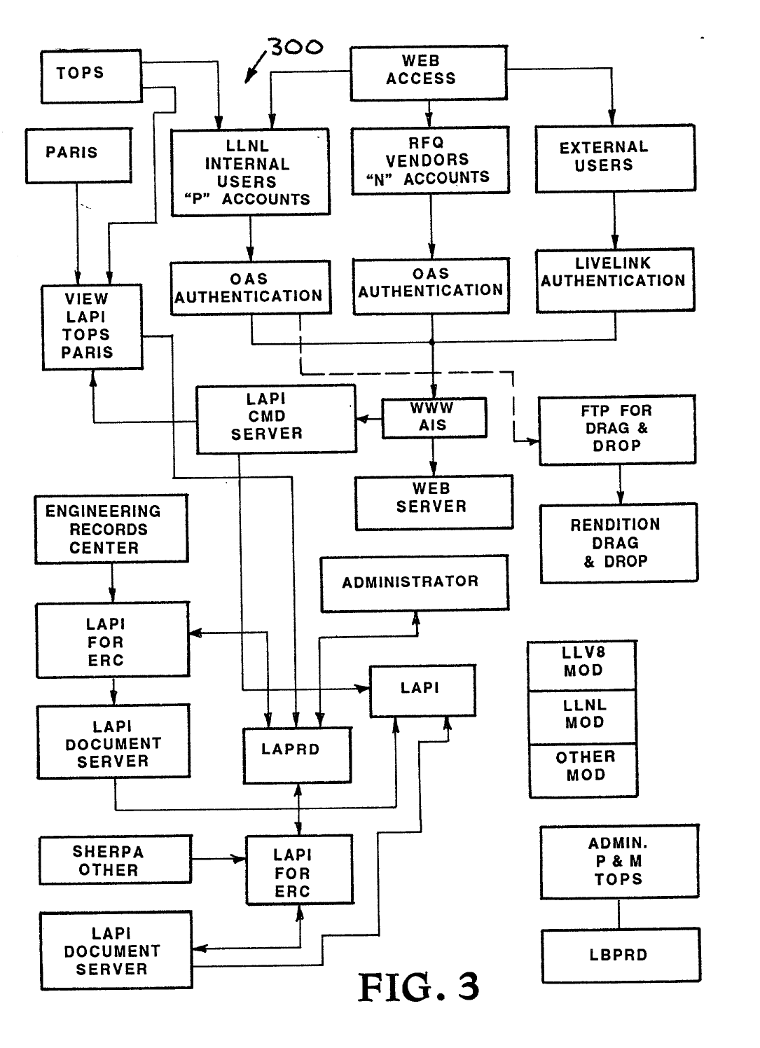

The iDocMan framework is based on the functionality of LiveLink, a commercial software product from Intranet software vendor Open Text. The software supports personalized working environments for external vendor access, and was customized to provide additional services such as automatic conversion of CAD files to PDF. All documents related to a fabrication request are now stored in a request folder in iDocMan, created through TOPS Job Order. Released drawings and other documents, such as specifications and parts lists from external systems, such as Sherpa's Product Data Management System and LIAM, are automatically transferred or aliased to the request folder. Authorized vendors access these documents through iDocMan as illustrated in FIG. 3.

LiveLink, designated generally by the reference numeral 300, is a management application for web-based solutions. A patent application covering the livelink management application for web-based solutions is described in U.S. patent application by Francine A. Alford and David L. Brinkerhoff, Ser. No. 09/656,484, filed Oct. 7, 2000, titled “A Method and System of Integrating Information From Multiple Sources,” and assigned to the Board of Regents of the University of California, the assignee of the present application. The specification, drawings, and disclosure of this patent application are incorporated herein in their entirety by reference. LiveLink is available from Open Text Corporation. Open Text's Livelink is a Web-based application that provides organizations with collaborative knowledge management solutions. Standard features include services for enterprise document and content management, business process automation, information retrieval, and virtual team collaboration through support for threaded discussions and group calendaring/scheduling. Available for Microsoft Windows NT, Windows 2000, HP-UX, and Sun Solaris server environments, Livelink requires a Web browser for end-user access, a Web server, and a relational database. Open Text extends Livelink's functionality through optional modules and software development tools, as well as through integration with third-party solutions. Optional modules provide capabilities such as Web crawling, records management, and Web publishing. The most recent version of Livelink provides the foundation for business-to-business collaboration.

LIAM is an integrated collaborative engineering and electronic commerce system developed by LLNL. LIAM is described in a paper by C. W. Jordan, W. A. Niven, K. Luu, F. A. Alford, K. Eiden, and F. E. Warren, titled “LIAM: integrating collaborative engineering and electronic commerce” presented at the Advanced Procurement and Logistics Systems (APLS)/Continuous Acquisition and Life-Cycle Support (CALS) Europe 99, London, United Kingdom, Oct. 12-14, 1999. The paper, drawings, and disclosure of which are incorporated herein in their entirety by reference.

Long term limited trading communities for optical components are critical to NIF success over a 30 year projected lifetime. Although engineering experimented with web-based applications in 1993-94, its first useful pilot application, Concurrent Engineering Rapid Prototype System (CERPS), appeared in 1995. CERPS, and later Zephyr were never intended for enterprise integration but meant to define systems requirements and explore the limits of web-security while delivering online engineering goods and services.

Zephyr is a demonstrated paperless way to get deliverables to clients—sooner and cheaper developed by LLNL. Zephyr, named in honor of the California Zephyr train, is the streamlined, practical expression of ECI. Ultimately, it means researchers will get to their science sooner and have more money left over to do science better. Zephyr relies on a concept called Engineering and Commerce on the Internet (ECI). ECI, a Lawrence Livermore National Laboratory initiative, means online integration of the concept-to-delivery and payment cycle. For program managers who need to lower their costs, ECI cuts labor time and allows secure financial and engineering transactions on the Internet. For engineers who want to rapidly prototype designs, ECI allows efficient collaboration and approval on the World Wide Web.

Zephyr is described in a paper by C. W. Jordan, W. A. Niven, R. E. Cavitt, J. M. Taylor, F. A. Alford, M. J. Mauvais, D. I. Vickers, R. L. Weaver, and F. E. Warren presented at CALS Expo International & 21st Century Commerce 1998, Global Business Solutions for the New Millenium, Long Beach, Calif., Oct. 26-29, 1998. The paper, drawings, and disclosure of which are incorporated herein in their entirety by reference.

TOPS is an LLNL application sponsored by the Procurement & Materiel Department. TOPS is used by delegated Technical Release Representatives (TRRs) to create and submit requisitions, track orders (LLNL charge card), and create and submit material requests electronically. TOPS is described in Report number: UCRL-MA-123989, “Total On-Line Purchasing System (TOPS) desk guide,” Corporate Author: Lawrence Livermore National Laboratory, Livermore, Calif., (1996). The report, drawings, charts, and disclosure of which are incorporated herein in their entirety by reference.

True enterprise integration at LLNL, between procurement and engineering, was accomplished with the introduction of the TOPS Job Order and LIAM. Many programs, including NIF, have not fully transitioned to enterprise integration. NIF provides a business case to develop interfaces, technical capabilities, and vendor relationships, which hold promise for leveraging Web based portal technology across the entire Laboratory Supply-Chain.

In most cases, NIF systems satisfy individual group needs. Nonetheless, in varying degrees they represent overlapping islands of automation which are neither programmatically integrated, interoperable, secure, nor in most cases extend beyond NIF Project itself. Over the last four years, NIF Project has adopted, modified, or developed numerous independent systems to satisfy administrative, scientific, or engineering needs:

Document Management (Documentum)

Metrology Data Management System (developed)

Product Data Management (Sherpa)

NIF Share Server System (developed)

Enterprise Resource Planning (Glovia)

CAD and CAM (AutoCAD and ProE)

Project Planning (PrimaVera)

LIAM (Livelink iDocMan)

CAD Document Management (ProPDM)

TOPS Job Order (Livelink iDocMan)

Without a comprehensive Information Technology plan which includes a higher level of enterprise integration (i.e. a portal concept) and interoperability between collaborators, manufactures, and vendors, the cost of ownership and issues of informational integrity offer strong challenges for effective information management. Until such programmatic systems are connected throughout the enterprise to trading community systems, NIF Information Technology is sub-optimal. Simply put, at one time there are too many “expert systems” and too few interoperable systems extended to the supply-chain.

The system 100 provides a solution that leverages a NIF system by extending procurement and engineering enterprise linkages to a limited optical-mechanical manufacturing community such as that illustrated in FIG. 1. NIF Project, procurement and engineering are linked through iDocMan's Web portal to vendors as illustrated in FIG. 1 through the TOPS Job Order and LIAM systems.

The system 100 provides a three-part solution to extend a NIF functionality, the Metrology Data Management System (MDMS), to the optical manufacturing community within the constraints of our observations and assumptions as stated above. First, The system 100 provides a vendor evaluator. The evaluator, purpose built for the optical manufacturing sector, will categorize vendors by manufacturing capability, capacity, tolerances, coatings, cleaning capability, quality standards, metrology, inspection, storage, etc. The evaluator will be applied in determining which sectors of the trading community are capable of bidding, formulating the bid package, and down-selecting to automatically formulate an “intelligent manufacturing resource planner”.

Second, The system 100 provides development of an “intelligent manufacturing resource planner” which routes (i.e. workflows) products between prime and secondary contractors. Such functionality fills a huge gap if more than one manufacturer is required to produce a product. The “planner” initiates and routes a manufacturing process from Prime-to-Secondary and Secondary-to-Secondary vendors while in near real-time gathering manufacturing “intelligence” such as inspection reports, non-compliance reports, material dispositions, metrology measurements, shipping and receiving information, and comments, (etc.); information will be reported in a single transactional report from start to finish; information returned will be automatically parsed to appropriate data structures. In effect, the intelligent manufacturing resource planner is a forms input workflow method, served through a Web portal, to effect efficient bidirectional inter-organizational information distribution of procurement, financial, technical, and manufacturing data. The system 100 provides expands traditional goods and services manufacturing, in that Sellers provide value added time-sensitive manufacturing “intelligence” information. Time sensitive manufacturing “intelligence”, a tangible and saleable Seller-Side asset, which is critical to the mitigation of buyer-side engineering and program scheduling risk since real-time information gathering allows time for buyer contingency planning. Buyers may offer Prime-Secondary Sellers long term trading alliances and/or prompt payment to each vendor as they complete their portion of the manufacturing process in exchange for time sensitive manufacturing information. In this instance, waiting for payment until an assembly is issued to finished goods inventory serves neither the buyers or sellers best interest. We found prompt payment is a good business practice that attracts and retains SME's due to the lowered risk of Seller cash flow management.

Third, The system 100 provides information for understanding limited trading community bid/quote strategies (i.e, buyer and seller “win-win” models), payment methodologies, and business drivers for acceptance of inter-operational enterprise business transactions in homogeneous international markets. Issues related to establishing optimal trading alliances, business-to-business trust mechanisms and methods of stimulating “friendly” (i.e. moderating hostile or overly aggressive bidding) competitive bidding in limited trading communities is of particular interest. Long-term limited trading communities, such as optical manufacturing, are critical to NIF success over its 30 year projected life-time.

The system 100 provides a model and architecture to support inter-organizational business transactions; in particular those that involve buying highly engineered optics and optical assemblies. The system 100 introduces a model for the extension of inter-organizational systems to support NIF optical manufacturing that takes into account requirements of the initiator-buyer and prospective sellers. The system 100 provides a buyer-side schema for supply-chain information management. Buyers, in addition to procuring optical goods and services, offer incentives for seller-side manufacturing “intelligence” to mitigate buyer-side engineering risk and NIF Project schedule impact. The system 100 links the Laboratory with its collaborators, industrial suppliers, and institutional purchasing processes through an enterprise information portal. Benefits resulting from implementation of this concept include but are not limited to: an Information Technology plan for comprehensive electro-optical manufacturing which extends automated bi-directional technical information exchange from program to collaborators, manufactures, and vendors; development of virtual manufacturing alliances which hold promise for driving alliances to maximize manufacturing efficiency and economic interests, reduce product cost, and increase competitive bidding; a self-documenting automated methodology to evaluate optical manufacturers and formulate a bid package through the use a supplier evaluator to determine which sectors in a trading community are capable of bidding on optical processes, custom optical components, and highly complex electo-optical mechanical assemblies; a manufacturing planner which directs workflow between prime and secondary contractors; gathering manufacturing information such as inspection reports, non-compliance reports, material dispositions, metrology measurements, shipping and receiving information; while automatically parsing paperless data into appropriate data structures; and a long term electro-optical manufacturing business model for efficient information management, project construction, program operations, and an alliance stabilization strategy.

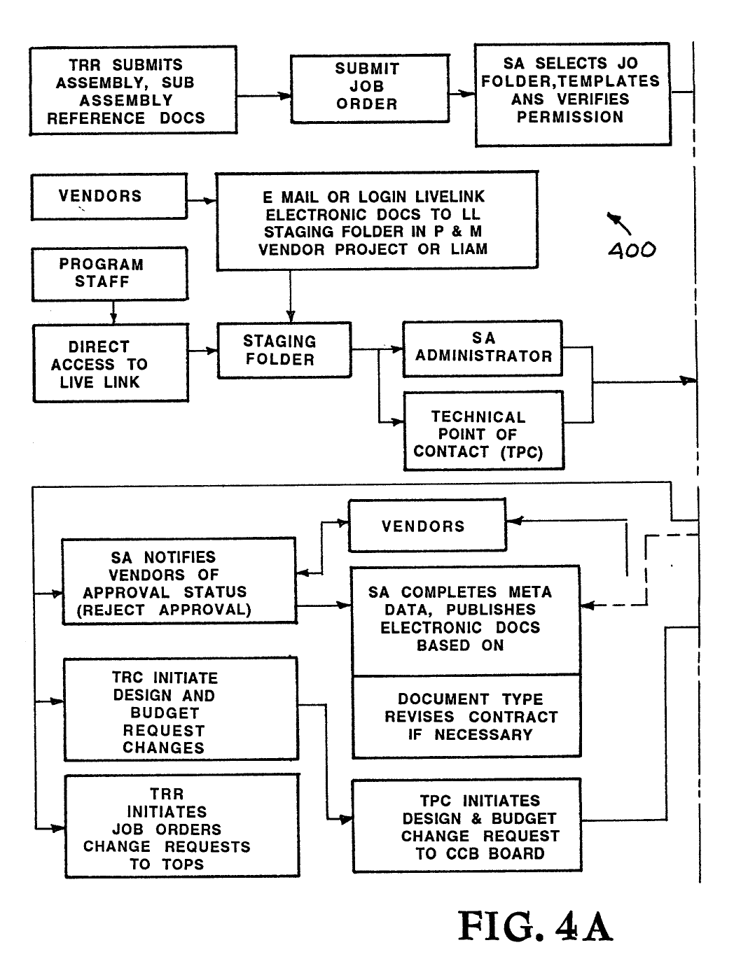

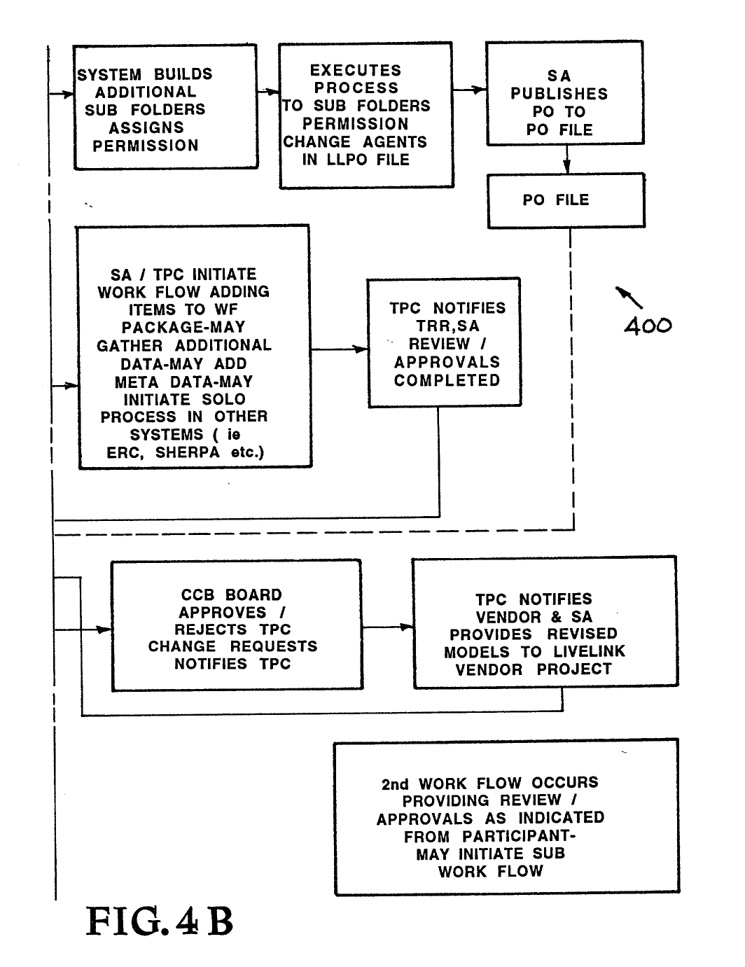

FIG. 4 illustrates another embodiment of the present invention. This embodiment will be designated generally by the reference numeral 400. The system 400 meets the long-term needs of both electronic document retention and retrieval. Procurement uses the Livelink (Docman) document management system to store and retain the formal electronic copies of PO contracts and related attachments, while still maintaining a manual paper file with all other related documents associated with the purchase.

The system 400 eliminates the need to maintain the manual file copies. It provides a consolidated document retention and electronic archive of Purchase order information including manufacturing information, enhancement requests, inspection reports, acceptance tests, serial numbers and email communications with vendors and program technical representatives. A review process will be included to allow for a formal documented technical review/communication by technical representatives and Vendors. Information contained in the file is accessible to P&M staff as well as selected program personnel.

The system 400 provides a long-term tool for all of procurement Subcontract Administrators to use to maintain electronic purchase order files for long term retention while satisfying the needs of the NIF program to capture and retain information during the manufacturing process. The system 400 maintains a simple folder structure in Livelink by Purchase Order or Release that supports filing of an electronic document, based on the document type. The document types are available from a pick list for the SA to assign to a document upon initiation to the review and approval workflow. When the SA publishes the document, upon completion of the review and approval cycle, allowing them to pick a folder category for filing purposes. The document types are initially mapped to a default folder category. It is possible, however, that the SA will file the same document type in different folder categories, depending on the origination of the document.

The system 400 provides a maintenance function in Livelink to add, change, or delete document types, and to map document types to default folder categories. This function is available to the SA while the documents are under contract, and available to the project thereafter.

The system 400 displays a general Metadata form for each document, based on the document type, which can be edited by the procurement team while the document moves through the approval workflow process, and must be competed by the SA when the document is published.

The system 400 will support an automatic agent that creates a Part#-/Serial# folder within a general NIF part document area, that aliases documents to it, based on the part-tab-rev number/serial number Metadata, when the SA publishes a document to one of the folder categories. This feature will not result in any additional effort for the SA, while at the same time, provides the project with an additional organizational structure for finding documents by part or serial number.

The system 400 provides visibility of all electronic documents, even as they move through the workflow process, with the following status indicators: Staged, In Work, or Published. The system 400 defines PO file subfolder templates based on program/project, type of award or other criteria as needed. Automate creation of sub folder structure based on pre-defined templates maintained in a table. The system 400 maintains Internal Access Control to PO folders. It maintains user roles on a contract basis, allows multiple people to assume the same role for access and workflows. It provides access for multiple users from vendor and limits their access to specific contract files. It maintains Vendor roles within the contract and provides ability to limit vendor access to email in only on a contract by contract basis.

The system is implemented using Livelink, NIF PICS, TOPS and PARIS environments. Data Base structure is Oracle Tables. The system interfaces to the AIS institutional systems: OLR, People, NIF database tables in Oracle and Sherpa.

System 400 displays a general Metadata form for each document, based on the document type, which can be edited by the procurement team while the document moves through the approval workflow process, and must be competed by the SA when the document is published. The general Metadata form should support the following fields:

| | Metadata Form Fields | |
|---|---|---|
| Metadata Field | Description | Pick list |
| PO or Release # | | Validate using |
| | | PARIS PO table |
| PO or Release Mod # | | |
| PO Document | | |
| Sequence # | | |
| Part # | | Validate Part # |
| | | Revision & Tab |
| | | using Glovia Part |
| | | Master |
| Tab # | | |
| Revision # | | |
| Part Description | 38 character description | Lookup Glovia |
| | | parts master, |
| | | based on part # |
| Vendor or LLNL | | |
| Serial #(s) | | |
| Lot #(s) | | |
| Requirement | The contract number of the | |
| Document | document that specified the | |
| | request for information, such | |
| | as scope of work, cleanliness | |
| | spec, etc. | |
| Document Type | | lookup to |
| | | Livelink |
| | | document type |
| | | table |
| Document Created | | |
| by Vendor Name or | | |
| LLNL Name | | |
| Document Creation | | |
| Date and Time | | |

Specific Metadata Maintenance

Display a specific Metadata form for each document, based on the document type, which can be edited by the procurement team while the document moves through the approval workflow process, and must be competed by the SA when the document is published. The specific Metadata forms for each document type are still in the process of being defined.

Automatic Alias Function

Support an automatic agent that creates a Part#-/Serial# folder within a general NIF part document area, that aliases documents to it, based on the part-tab-rev number/serial number Metadata, when the SA publishes a document to one of the folder categories. This feature will not result in any additional effort for the SA, while at the same time, provides the project with an additional organizational structure for finding documents by part or serial number.

The part/serial number folder structure is structured as follows:

Part-Tab-Rev Number 1 Folder

General Part Documents

Serial Number Folder 1

Specific Serial Number 1 Documents

Serial Number Folder n

Specific Serial Number n Documents

Part-Tab-Rev Number n Folder

General Part Documents

Serial Number Folder 1

Specific Serial Number 1 Documents

Serial Number Folder n

Specific Serial Number n Documents

Electronic Document Status

Provide visibility of all electronic documents, even as they move through the workflow process, with the following status indicators: Staged, In Work, or Published

Staged, In Work, or Published

Published Status includes: Acceptable or Acceptable with Revs

If the published status is Acceptable with Revs, a workflow will be triggered that indicates a revision of the submittal is pending, and will update the version of the document that was published when the revised document is approved with the appropriate status

If a submittal is Not Acceptable, it will not be published

Access Control Functionality

Maintain Access Control to PO folders. Assign user roles on a contract basis; allow multiple people to assume the same role for access and workflows. Provide access for multiple users from vendor and limit their access to specific contract files. Maintain Vendor roles within the contract.

Internal Access Control

Maintain Access Control to PO folders. Assign user roles on a contract basis; allow multiple people to assume the same role for access and workflows. Maintain user to role identification within contract. Start identification of these roles at the initial requisition, transfer control to the contract (PARIS PO or Livelink Contact file) upon award of the contract or publishing of the PO document. Auto create associated Livelink groups/users from requisition/PO. Allow for modification of users assigned to roles throughout the life of the contract via one interface to the SA.

External Vendor Access Control

Provide access for multiple users from vendor and limit their access to specific contract files. Maintain Vendor roles within the contract. Maintain user to role identification within contract. Start identification of these roles at the initial requisition, transfer control to the contract (PARIS PO or Livelink Contact file) upon award of the contract or publishing of the PO document. Auto create associated Livelink groups/users from PO. Allow for modification of users assigned to roles throughout the life of the contract via one interface to the SA.

Workflow Processing

Create Workflow templates for Vendor and Internal document transfer processing. Automate the creation of specific contract workflows using contract roles tables to populate workflows. Provide maintenance function to update workflows previously deployed. Populate workflow and document attributes from a single entry point. Auto initiate workflows from staging areas. Create scripts for Autofiling selected documents to PO folder and Vendor staging area.

Data Entry Simplification

The system is designed to create a PO File/sub file, user access quickly and easily. The goal is to minimize any dual entry of Metadata between systems. To automate administrative tasks when possible.

User Types and Privileges

Roles will be established on a contract by contract basis based on the
following Role Templates

| | | Consequences if |
|---|---|---|
| Role | Access | Compromised |
| Contract SA | Read/Write, | Contract may be |
| | workflow role | compromised resulting |
| | | in LLNL legal |
| | | obligations |
| Contract TPOC | Read all folders | Contract may be |
| | Write to | compromised resulting |
| | Staging areas, | in invalid or incorrect |
| | Workflow role | technical specifications |
| | | or direction |
| Contract | Read all folders | Contract may be |
| Procurement team | Write to | compromised all data |
| | Staging areas | entered is reviewed by |
| | | TPC/SA |
| Contract Vendor | Read/Write- | Contract may be |
| Procurement | Vendor Staging | compromised resulting |
| Team | area only | in invalid or incorrect |
| | Read Vendor | technical specifications |
| | Proj. & LLNL | or direction, all data |
| | Transfer folder | entered is reviewed by |
| | | TPC/SA |
| Contract Vendor | Read/Write | Contract may be |
| Design Team | LLNL | compromised resulting |
| | Read Vendor | in invalid or incorrect |
| | Proj & LLNL | technical specifications |
| | Transfer folder | or direction, all data |
| | | entered is reviewed by |
| | | TPC/SA |
| Contract Vendor | Read/Write | Contract may be |
| Proj. Mgr. | LLNL | compromised resulting |
| | Read Vendor | in invalid or incorrect |
| | Proj & LLNL | technical specifications |
| | Transfer folder, | or direction, all data |
| | workflow role | entered is reviewed by |
| | | TPC/SA |
| P&M | Read Only | Limited risk |
| Procurement | | |
| Staff | | |
| NIF User | Read Only | Limited risk |

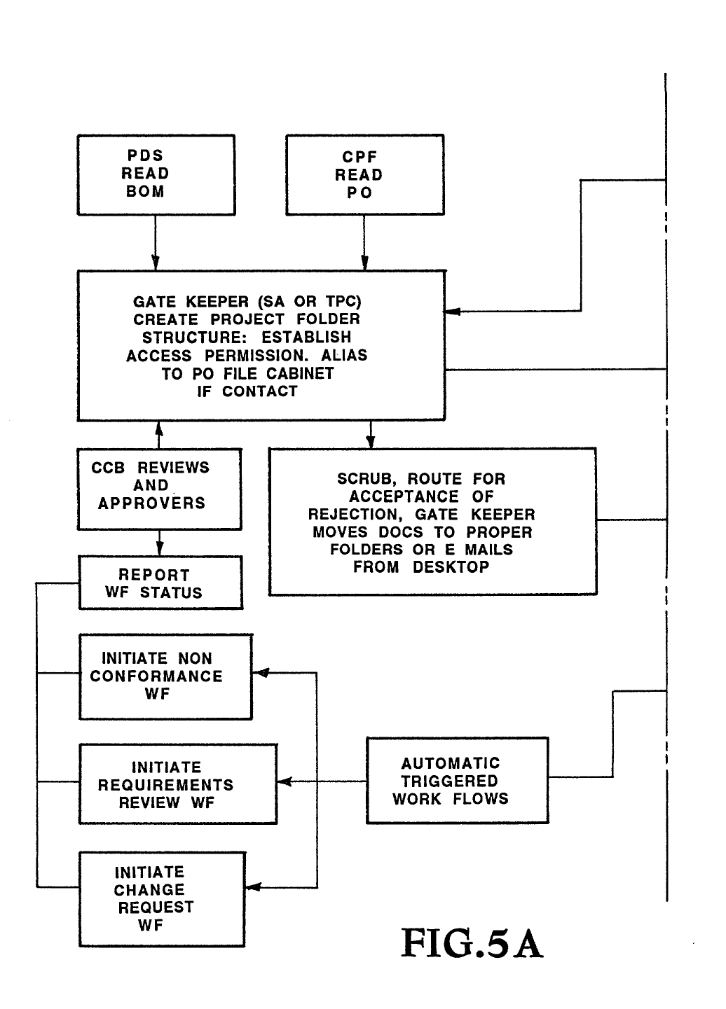

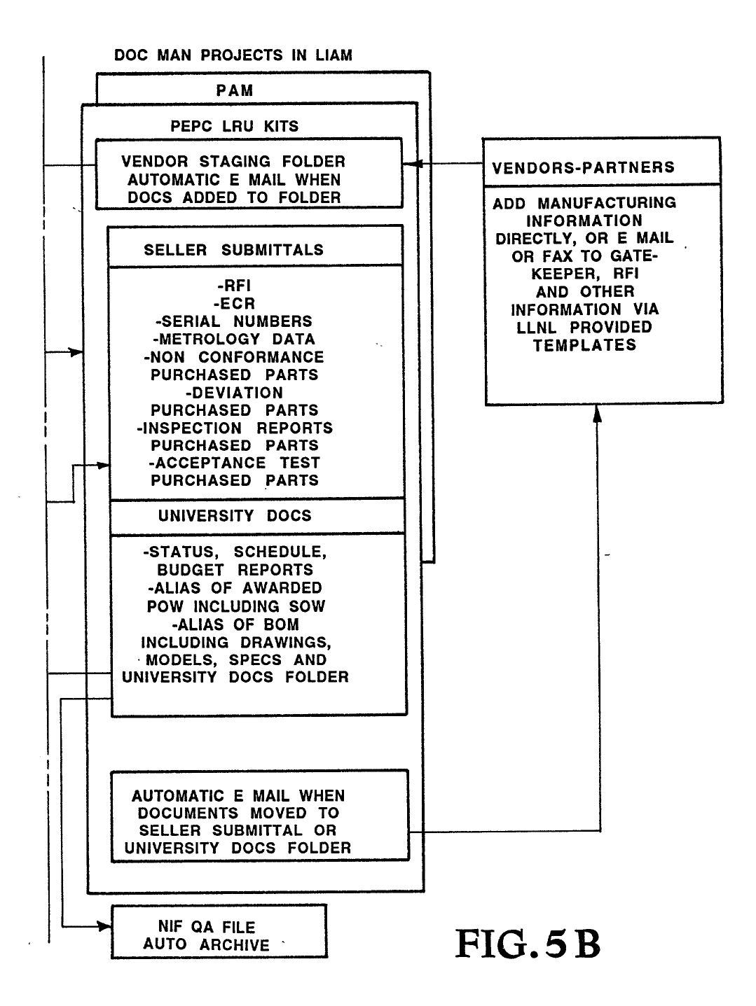

Referring now to FIG. 5 another embodiment of a system is illustrated which provides enhanced functionality for processing manufacturing procurement orders where multiple business entities are required to produce a finished product or goods. The system is generally designated by the reference numeral 500. The system 500 is useful to engineering and manufacturing clients such as (but not limited to) NASA, DoD, DOE, Boeing, Lockheed, TRW, GE, Ford, Nissan, GM, Motorola, or any manufacturing entity in the aerospace, automotive, avionics, or consumer products business sectors. The system 500 extends to procurement and manufacturing information technology for commercial internet business-to-business providers such as Ariba, CommerceOne, Livelink-B2B, and PeopleSoft but is applicable to a multitude of business entities involved in procurement of manufactured goods and services.

One of the biggest problems confronting businesses today is proper tracking of procurement manufacturing environments where there are multiple components being iteratively processed and re-released to multiple outside organizations. It is often desirable to record and track all manufacturing procurements, fix in a given manufacturing release, ensure the proper fixes are applied to the correct releases, and bi-directionally communicate in-process manufacturing information. Today, the marketplace demands efficient highly automated tracking of such information with little tolerance for mistakes. There is a need for a robust procurement-engineering solution which can be applied to many types of data management systems encompassing engineering design conceptual capture, global collaborative concurrent engineering, design control and iteration, data gathering to develop a manufacturing procurement, preparation of a manufacturing bid package, contract award, workflow management of manufacturing processes between buying organizations and various world wide seller manufacturing sites, gathering in-process manufacturing intelligence and shipping information, parsing in-process information into appropriate comprehensive data structures, tracking finished goods to inventory, and corporate payment mechanisms.

There is a need for integrators/coordinators/model builders and the designers to work together to create a next release. Information from different people in different forms must be collected aiming at a final good design. A problem occurring during product development is, how to know which people to contact for what kind of information, but that is only one problem. During all of the process concurrent engineering, particularly for the needs of complex very large scaled integrated system design, the release needs to keep everything in order and on track, while allowing people to work on many different aspects of the project at the same time with differing authorizations of control from anywhere at anytime.

The system 500 encompasses the ability to integrate CIM, EDA, PDM and PIM and because it has the modularity making it possible to fulfill these needs in a concurrent engineering environment particularly useful to the design of complex very large scaled integrated systems as employed in a computer system itself. The making of these systems is a worldwide task requiring the work of many engineers, whether they be employed by the manufacturer or by a vendor, working in parallel on many complete parts or circuits which are sub-parts of parts.

There are two preeminent vendors of development software, Cadence Design Systems, Inc. and ViewLogic, Inc. Of course there are others, but these two companies may have a greater range of capability than the others. Also, there are in house systems, such as IBM's ProFrame which we think is unsuitable for our use. It will not function well as a stand-alone DM point tool for integration into a foreign framework. But even the largest microelectronic systems are customers of the two named vendors.

The most common method in use today is to create a listing of files commonly referred to as a Bill of Materials. Many commercial products permit creation of such a BOM, but these BOM are static list BOM. For example, as one of the members of the BOM disappears or changes, the user is unaware the original data set used to create the BOM is no longer valid.

The system 500 address problems confronting businesses today including: proper tracking of procurement manufacturing environments where there are multiple components being iteratively processed and re-released to multiple outside organizations. The system 500 will: record and track all manufacturing procurements, fix in a given manufacturing release, ensure the proper fixes are applied to the correct releases, and bi-directionally communicate in-process manufacturing information. The system 500 enables world wide business-to-business procurement of manufactured goods and services, national and international collaboration, engineering document and manufacturing 3D model management, a vendor evaluator, bid-quote selection, award, intelligent work flow routing between prime and secondary contractors, and manufacturing intelligence gathering. The system 500 provides enhanced functionality for processing manufacturing procurement orders where multiple business entities are required to produce a finished product or goods. The system 500 is useful to engineering and manufacturing clients such as (but not limited to) NASA, DoD, DOE, Boeing, Lockheed, TRW, GE, Ford, Nissan, GM, Motorola, or any manufacturing entity in the aerospace, automotive, avionics, or consumer products business sectors. The system 500 extends present procurement and manufacturing information technology for commercial internet business-to-business providers such as Ariba, CommerceOne, Livelink-B2B, and PeopleSoft but is applicable to a multitude of business entities involved in procurement of manufactured goods and services.

The system 500 can be applied to many types of data management systems encompassing: engineering design conceptual capture, global collaborative concurrent engineering, design control and iteration, data gathering to develop a manufacturing procurement, preparation of a manufacturing bid package, contract award, workflow management of manufacturing processes between buying organizations and various world wide seller manufacturing sites, gathering in-process manufacturing intelligence and shipping information, parsing in-process information into appropriate comprehensive data structures, tracking finished goods to inventory, and corporate payment mechanisms. Benefits resulting from implementation of this concept include: an information technology for comprehensive manufacturing which extends automated bidirectional technical information exchange from buyers to collaborators, manufactures, and vendors; development of virtual manufacturing alliances which hold promise for driving alliances to maximize manufacturing efficiency and economic interests, reduce product cost, and increase competitive bidding in limited global trading communities; a self-documenting automated methodology to evaluate manufacturers and formulate a bid package through the use a supplier evaluator to quantitatively define which sectors in a trading community are capable of bidding on manufacturing processes, purpose built components, and complex electronic, optical, and mechanical assemblies; a knowledge-based manufacturing planner which automatically directs workflow between prime and secondary contractors; gathering manufacturing intelligence such as (but not limited to) inspection reports, non-compliance reports, material dispositions, metrology measurements, shipping and receiving information while parsing paperless information into appropriate data structures in near real-time at the buyer's site; a new tangible (and saleable) seller asset called “time-sensitive manufacturing intelligence”. Such prompt intelligence is critical to the mitigation of buyer-side engineering and program scheduling risk. This new tangible asset is only made possible by near real-time intelligence gathering implemented though a novel application of information technology; and a long term procurement and manufacturing embodiment for more efficient procurement, information management, project construction, program operations, and trading alliance stabilization strategies.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

Various acronyms and abbreviations have been used throughout the description of the embodiments to describe components and subsystems of the embodiments. The following publications describing the components and subsystems are incorporated herein by reference: J. Gebauer, et al., “Building an Internet-based Workflow System—The Case of Lawrence Livermore National Laboratories' Zephyr Project,” Fisher Center Working Paper 98-WP-1030, April 1998; J. Gebauer, et al., “Building an Internet-based Workflow System—The Case of Lawrence Livermore National Laboratories' Zephyr Project,” IDEA Group Publishing, #IT5544, 1999; J. Gebauer, et al. “From Pilot to Practice—Streamlining Procurement and Engineering at Lawrence Livermore National Laboratory,” Annals of Cases on Information Technology Applications and Management in Organizations, Volume 2, 2000; C. W. Jordan, et al. “Integrating Collaborative Engineering with the Enterprise,” Lawrence Livermore National Laboratory, Advanced Procurement and Logistics Systems (APLS)/Continuous Acquisition and Life-Cycle Support (CALS) Europe 99, London, United Kingdom, Oct. 12-14, 1999; C. W. Jordan, et al. “LIAM: Integrating Collaborative Engineering and Electronic Commerce,” Advanced Procurement and Logistics System (APLS)/Continuous Acquisition and Life-Cycle Support (CALS), London, UK, Aug. 6, 1999; “Military Standard (Contractor Integrated Technical Information Service (CITIS)),” IL-STD-974, Department of Defense, Aug. 20, 1993; C. W. Jordan, et al., “Using the World-Wide Web as a Medium for Concurrent Engineering and Rapid Prototyping,” Information Engineering, Thrust Area Report FY95; and C. W. Jordan, et al., “Zephyr: A Secure Internet-Based Process to Streamline Engineering,” UCRL-JC-131261 Preprint, CALS Expo International & 21st Century Commerce 1998 and AACE Association for the Advancement of Computing in Education WebNet98, 1998, July 1998.

The invention claimed is:

1. A computer and internet implemented method for supporting inter-organizational business transactions, comprising the steps of:
preparing fabrication files,
validating drawings and/or models,
obtaining manufacturing documents,
obtaining reference specifications,
accessing procurement packages for bidding,
awarding orders,
accessing manufacturing packages for fabrication, and
entering shipping information.

2. The computer and internet implemented method for supporting inter-organizational business transactions of claim 1, including creating internet based connections for preparing fabrication files and/or validating drawings and/or models and/or obtaining manufacturing documents and/or obtaining reference specifications and/or accessing procurement packages for bidding and/or awarding orders and/or accessing manufacturing packages for fabrication and/or entering shipping information.

3. The computer and internet implemented method for supporting inter-organizational business transactions of claim 1, including adding local documents.

4. The computer and internet implemented method for supporting inter-organizational business transactions of claim 1, including entering fabrication requests on job orders.

5. The computer and internet implemented method for supporting inter-organizational business transactions of claim 1, including entering requests for information.

6. The computer and internet implemented method for supporting inter-organizational business transactions of claim 1, including entering engineering change requests.

7. The computer and internet implemented method for supporting inter-organizational business transactions of claim 1, including entering engineering change orders.

8. The computer and internet implemented method for supporting inter-organizational business transactions of claim 1, including entering material dispositions.

9. The computer and internet implemented method for supporting inter-organizational business transactions of claim 1, including entering inspection documents.

10. The computer and internet implemented method for supporting inter-organizational business transactions of claim 1, including collaborating the validating drawings and/or models and accessing procurement packages for bidding.

11. The computer and internet implemented method for supporting inter-organizational business transactions of claim 10, wherein said step of collaborating the validating drawings and/or models and accessing procurement packages for bidding occurs prior to said step of awarding orders.

12. The computer and internet implemented method for supporting inter-organizational business transactions of claim 10, wherein said step of collaborating the validating drawings and/or models and accessing procurement packages for bidding occurs after said step of awarding orders.

13. A computer-implemented method for supporting inter-organizational business transactions, comprising the steps of:
preparing fabrication files,
entering fabrication requests on job orders,
validating drawings and/or models,
obtaining manufacturing documents,
obtaining reference specifications,
adding local documents,
accessing procurement package for bidding,
awarding orders,
access manufacturing package for fabrication,
entering requests for information,
entering engineering change requests,
entering engineering change orders,
entering material dispositions,
entering inspection documents, and
entering shipping information.

14. The intelligent inter-organizational computer-implemented method for supporting inter-organizational business transactions of claim 13 wherein said step of entering fabrication request includes creating internet based request for quote.

15. The intelligent inter-organizational computer-implemented method for supporting inter-organizational business transactions of claim 13 wherein said step of validating drawings and/or models includes transferring drawings and/or models.

16. The intelligent inter-organizational computer-implemented method for supporting inter-organizational business transactions of claim 13 wherein said step of obtaining manufacturing documents includes transferring drawings and/or models.

17. The intelligent inter-organizational computer-implemented method for supporting inter-organizational business transactions of claim 13 wherein said step of obtaining reference specifications includes referencing cleanliness specifications.

18. The intelligent inter-organizational computer-implemented method for supporting inter-organizational business transactions of claim 13 wherein said step of adding local documents includes transferring other necessary documents.

19. A computer-implemented method to support inter-organizational business transactions, comprising the steps of:
creating folders within the PO file structure using standard Management application for web-based solutions add folder command develop;
accessing control via Management application for web-based solutions permissions using User and Group maintenance functions;
creating workflow processes for document exchange for both internal and external document exchange using standard Management application for web-based solutions workflow functions;
creating interim documentation for vendors and program file users;
capturing Meta data associated with workflows and documents using standard Management application for web-based solutions categories;
using workflow to transfer documents and identify meta data;
collecting vendor input in staging area via fax, e-mail, and e-mail attachments using standard Management application for web-based solutions functionality;
identifying design issues with initial requirements;
identifying what can be done with base Management application for web-based solutions function; identifying what must be created with custom code;
identifying what can be improved with automation, within Management application for web-based solutions or other integrated systems;
determining procedure/policies needed to support the system; and
prioritizing custom design and programming requirements.

20. A computer-implemented method for supporting inter-organizational business transactions, comprising the steps of:
means for preparing fabrication files,
means for entering fabrication requests on job orders,
means for validating drawings and/or models,
means for obtaining manufacturing documents,
means for obtaining reference specifications,
means for adding local documents,
means for accessing procurement package for bidding,
means for awarding orders,
means for accessing manufacturing package for fabrication,
means for entering requests for information,
means for entering engineering change requests,
means for entering engineering change orders,
means for entering material dispositions,
means for entering inspection documents, and
means for entering shipping information.

21. The intelligent inter-organizational computer-implemented system for supporting inter-organizational business transactions of claim 20 wherein said means for entering fabrication request includes means for creating internet based request for quote.

22. The intelligent inter-organizational computer-implemented system for supporting inter-organizational business transactions of claim 20 wherein said means for validating drawings and/or models includes means for transferring drawings and/or models.

23. The intelligent inter-organizational computer-implemented system for supporting inter-organizational business transactions of claim 20 wherein said means for obtaining manufacturing documents includes means for transferring drawings and/or models.

24. The intelligent inter-organizational computer-implemented system for supporting inter-organizational business transactions of claim 20 wherein said means for obtaining reference specifications includes means for referencing cleanliness specifications.

25. The intelligent inter-organizational computer-implemented system for supporting inter-organizational business transactions of claim 20 wherein said means for adding local documents includes means for transferring other necessary documents.

26. An intelligent inter-organizational computer-implemented system to support inter-organizational business transactions, comprising:
a component for preparing fabrication files,
a component for entering fabrication requests on job orders,
a component for job ordering/validating drawings/modeling,
a component for job ordering/obtaining manufacturing documents,
a component for job ordering/obtaining reference specs,
a component for job ordering/adding local documents,
a component for accessing procurement package for bidding,
a component for awarding orders,
a component for access to manufacturing package for fabrication,
a component for entering inspection documents, and
a component for entering shipping information.

27. The intelligent inter-organizational computer-implemented system to support inter-organizational business transactions of claim 1, including a component for collaborative engineering and procurement prior to and after contract award.

28. An intelligent inter-organizational computer-implemented system to support inter-organizational business transactions, comprising:
a standard management application for web-based solutions add folder component for creating folders within a PO file structure,
a management application for web-based solutions permissions user and group maintenance functions component for access control,
a standard management application for web-based solutions workflow functions component for creating workflow processes for document exchange both internal and external,
a component for creating interim documentation for vendors and program file users,
a standard management application for web-based solutions categories component for capturing meta data associated with workflows and documents,
a component using workflow to transfer documents and identify meta data, a fax, e-mail, and e-mail attachments component for collecting vendor input in staging area using standard management application for web-based solutions functionality,
a component identifying design issues with initial requirements,
a component identifying what can be done with base management application for web-based solutions functions,
a component identifying what must be created with custom code,
a component identifying what can be improved with automation, within a management application for web-based solutions or other integrated components,
a component determining procedure/policies needed to support the component, and
a component prioritizing custom design and programming requirements.
